(19) United States
(12) Patent Application Publication
(10) Pub. No.: US 2006/0165833 A1
(43) Pub. Date: Jul. 27, 2006

(54) Device for extruding curved extruded profiles

(76) Inventors: Uwe Muschalik, Duisburg (DE); Nikolaus Jakoby, Ratingen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/548,618

(22) PCT Filed: Mar. 4, 2004
(86) PCT No.: PCT/DE04/00416

§ 371 Date: Sep. 6, 2005

(30) Foreign Application Priority Data
Mar. 12, 2003 (DE) 103 11 169.7

(51) Int. Cl. B29C 59/00

(52) U.S. Cl. 425/296; 425/393; 425/308

(57) ABSTRACT

The invention relates to a device for extruding curved extruded profiles (4a, 4b). The extruded profile (4a, 4b) is formed in a matrix mounted upstream from a counter beam (5) of an extruder system and is subsequently curved or bent due to the effect of external forces and separated into partial lengths (4) in the extrusion flow. The partial lengths are transported from the extrusion outlet and cooled. A rotating table (7) is arranged in the extrusion outlet in order to receive the curved extrusion profiles (4).

The invention relates to an apparatus for extruding curved profiles, the extruded profiles being formed in a die held in a frame of an extruder and then being curved or bent by the application of an external force, and then cut downstream into lengths that are conveyed away for cooling.

To convey extruded profiles away from a rod or tube or combined rod/tube press an outlet conveyor is operated by the production program. Thus when extruding rods, profiles, pipes, and tubes the extruders produce a straight profile, while for making wire the extruders are set up to feed to a downstream reel. When extruding straight profiles there is downstream of the extruder frame a set of idler guide rollers. With windup systems the roller conveyor can extend off laterally to make place for the wire channels. Downstream therefore there is a driven lowerable roller conveyor with cast plates between the driven lowerable rollers. In order to avoid drooping of the extruded workpiece between the rollers that would impart to it a permanent deformation, the rollers are dropped after the extrusion operation and then the extruded workpiece or profile is laid on the plates or a table. From this position it can be transported off in the normal manner.

EP 0,672,473 describes a drum rotatable about a horizontal axis, serving for conveying off straight extruded profiles, and provided on its periphery with uniformly distributed profile holders each of which is loaded during rotation with an extruded profile and then unloaded during each rotation. The profile holders of the drum are set up also to cool the extruded profiles.

To produce the various extruded profiles that are used in different industrial applications. e.g. roof trusses, shock absorbers, and the like, and that are normally made of aluminum and magnesium alloys, EP 0,706,843 proposes a method of extruding thick-wall tubular product in which at a short spacing downstream from the die or frame a pusher (guide tool) exerts a force on the extrusion that is effective all the way back to where the extrusion is in the die. The pusher can be a roller, a deflecting slide surface, an array or rollers, or a similarly effective workpiece. The workpiece is permanently plastically deformed into the desired bent or curved shape downstream of the extruder.

The extrusion that is continuously bent to one side or the other is then cut into the desired lengths. German 101 20 953 does this by flame cutting so as to avoid changing the bent shape of the extrusion so that it would require an additional processing step, e.g. calibrating by internal high-pressure deformation, in order to get the extrusion to the desired final shape.

It is an object of the invention to provide such an apparatus that makes it possible to convey away the lengths of extruded profiles bent into one or more arcs without deleteriously affecting the extrusion method and process.

This object is attained according to the invention in that a turntable is provided at a press outlet to receive the curved extruded profiles. The turntable according to the invention is extremely easy to adjust so as to accommodate different lot sizes produced by converting standard billets each into a plurality of lengths. The turntable can be rotated in steps or continuously and be loaded with profiles one after the other or in parallel groups. This can for example be done by a multiaxis manipulating robot or the like. e.g. integrated unloaders or lifters. In addition the diameter of the turntable makes it possible from the start to accommodate the arcuate shapes of the extruded profiles to be processed. To this end it is within the scope of possibilities to form the turntable as two integrated corotating or counterrotating turntables. The extruded profiles are set directly onto the turntable, preferably in a mesh net, for example of wire, aluminum or graphite, or in webbing. e.g. of Kevlar. Alternatively clips, holding arms, or similar seats are possible.

According to a preferred embodiment of the invention above and/or below the turntable there are cooling means. If cooling means is provided next to the nonstraight extruded profiles it is possible to intensively cool the entire outer surface of the extruded profiles. In this manner the cooling is uniform so that there will be no deformations and the imparted curvature or shape of the extruded profiles is maintained.

If the turntable according to the invention is provided with spoke-like arms, room is left for free passage of the coolant, e.g. air, from coolers underneath the turntable to the extruded profiles resting thereon. They are thus fully exposed to the flow of coolant.

According to a suggestion of the invention the coolers are grouped in zones, preferably in segment-like housings. In this manner the individual cooling zones can not only be turned on or directed according to the length or other dimensions of the extruded profiles but as a result of the modular construction it is possible to switch or change complete segment housings, e.g. hoods, simply according to the current extrusion program, switching them with segments having a shape or nozzle setup complying with the profile or workpiece. The connections of the housing segments need then merely be coupled up to the central coolant supply.

The nozzles can be flat or hole nozzles that are offset and/or alternated. Axial or radial blowers provide cost-effective cooling. In any case it is possible to distribute the cooling zones, the diameter of the turntable preferably being the cooling-zone length, in an arc of 45°, to provide any desired cooling, e.g. with smaller extruded profiles only a few cooling zones are used or the cooling capacity is reduced. In addition the cooling zones or their nozzles can be provided axially above and/or below the inner or outer periphery or the central diameter as well radially on the inner and/or outer periphery of the arcuate extruded profiles.

According to an embodiment of the invention the turntable has at least one loading station and one unloading station that can be opposite one or another or next to one another. Preferably there is a combined loading and unloading station, preferably with extruded profiles of double length, that is an arc or 90° instead of 45°. In this case it is advisable that the coolers be raisable and lowerable so that with a combined loading and unloading station a housing or segment can be raised into an out-of-the-way position for loading.

A further preferred embodiment is that air-exhaust conduits are provided on the turntable. A central chimney-like vent can be provided at the center of the turntable to recycle the waste heat, for example for feeding or supplying a furnace, such as a curing, die-warming, or billet-preheating furnace.

According to a preferred embodiment of the invention it is suggested that the turntable be combined with a straight roller conveyor. The extruder can thus be used to make straight extrusions. The straight roller conveyor can be fitted tangentially between the spokes. In this manner it is possible in a simple way to retrofit or integrate the turntable into existing setups.

With a straight roller conveyor it is advisable to provide it with cooling zones like the turntable according to the invention. The cooling can be varied as desired when producing straight extruded profiles.

Further particular features of the invention are seen in the claims and the following description of embodiments of the invention shown in the drawing. Therein:

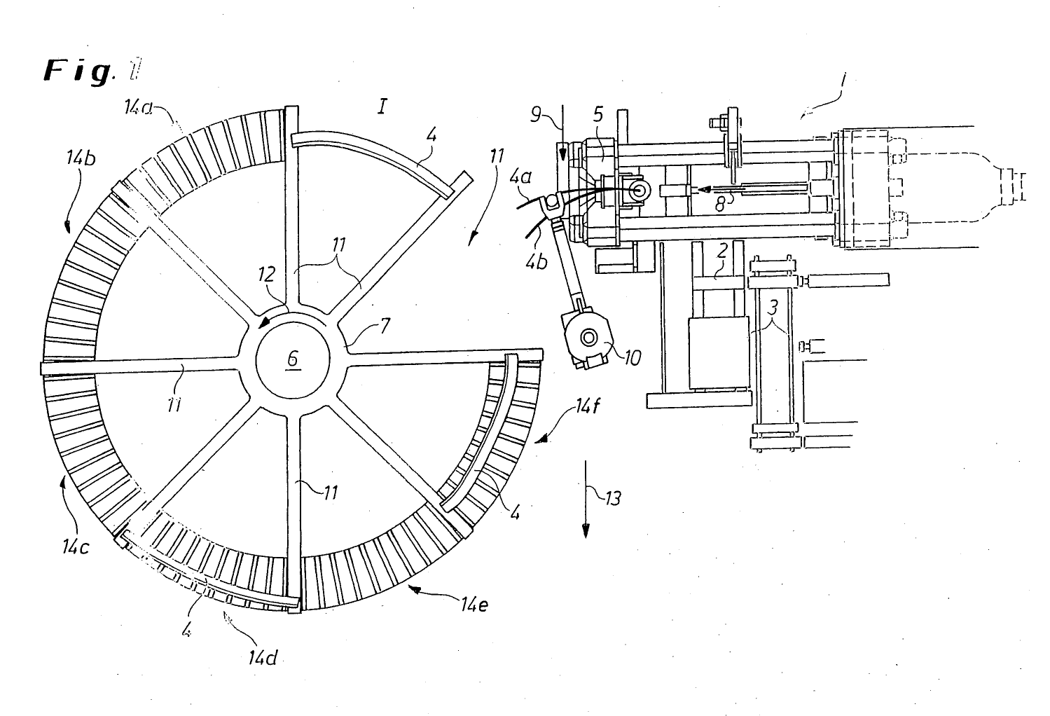

FIG. 1 is a schematic top view of an extruder with a turntable at its outlet;

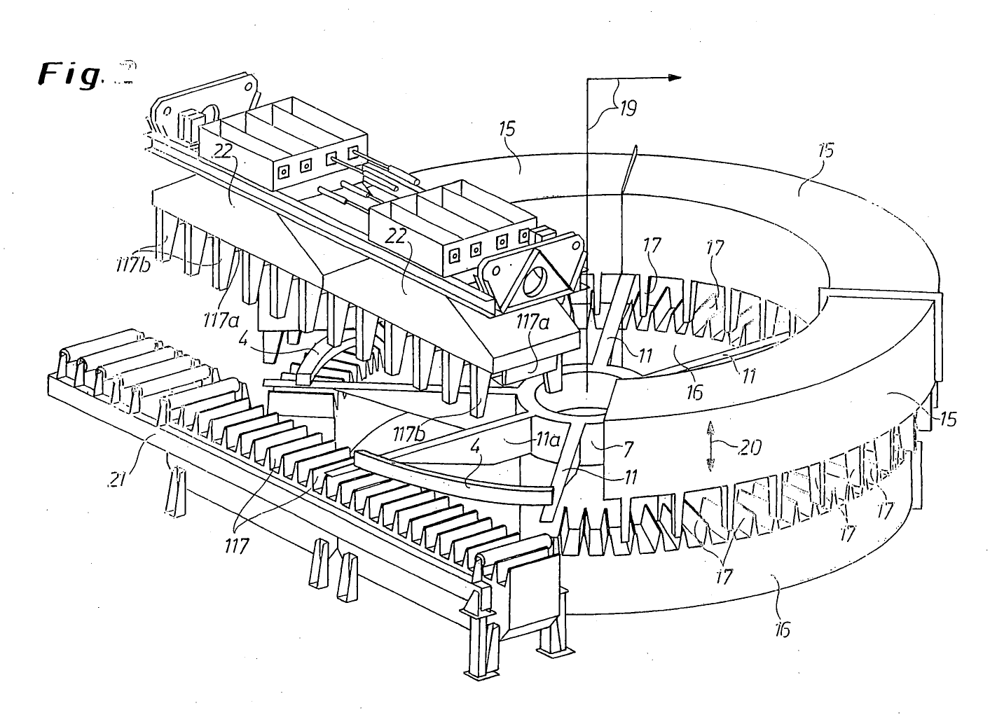

FIG. 2 is a perspective view of details of a turntable with cooling segments in combination with a straight roller conveyor provided with coolers for use with straight extruded profiles; and

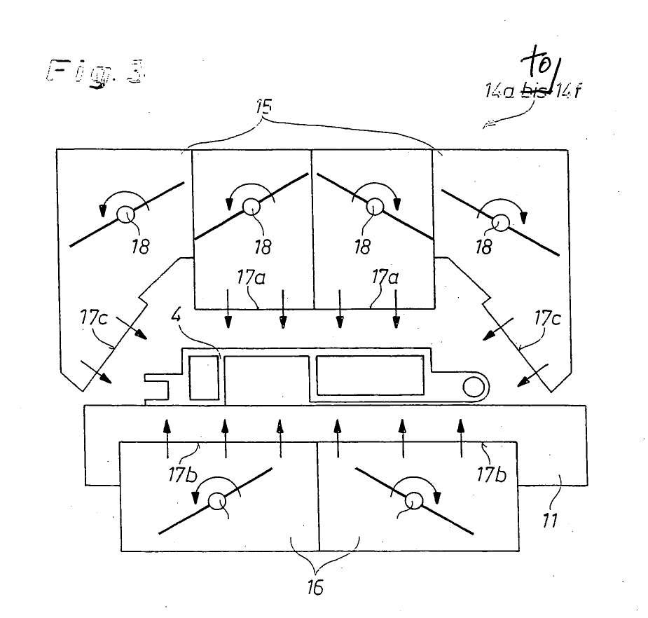

FIG. 3 is a detail schematic view of the coolers in zones set up to distribute the coolant over the entire surface of an extruded profile.

An extruder 1 shown in FIG. 1 is fed billets 2 by means of a loader 3. Profiles 4a and 4b of two different radii are extruded through a die from a frame 5 and come to rest on a turntable 7 provided at a press outlet I and rotated continuously or in steps about a vertical axis 6.

In this embodiment the arcuate extruded profiles 4a and 4b are bent to one side from a straight extrusion direction 8 to a constant curvature. The bending of the strand to the desired radius takes place downstream of the frame 5 as shown schematically by a guide tool shown schematically at 9 and an unillustrated curvature detector. The lengths of arcuate extruded profile 4a and 4b are created by a cutter, e.g. a shear, immediately downstream in the direction 8 from the extruder 1, and then are picked up by a multiaxis robot 10 and set on the turntable 7, if necessary in special unillustrated profile seats (e.g. webs or nets, clips, or the like).

The turntable is provided with spokes 11 spaced apart by about 45°. Each pair of adjacent spokes 11 supports a curved extruded profile 4; even though FIG. 1 only shows a load of three curved extruded profiles 4 so the robot 10 can preferably load each empty space between adjacent spokes 11 with extruded profiles one after or parallel next to one another.

Instead of the common loading and unloading station 11 of FIG. 1 from which the robot 10 can unload one of the cooled extruded profiles after one revolution in the rotation direction 12 (see the arrow) and pass it off to an outgoing roller conveyor shown schematically at 13, an unloading station can for example be set at another location around the turntable 7. A robot or the like for automatic unloading must be provided there.

For intensely cooling the curved extruded profiles 4, 4a, and 4b on their path between where they are loaded onto and taken off the turntable 7 there are underneath and above the spokes 11 and laterally spaced from the curved extruded profiles 4, 4a, and 4b several individually switchable cooling zones 14a to 14f; unlike the illustrated example it is also possible to provide a single cooling zone extending over 360°. The cooling zones 14a to 14f are made modular as segments and have in upper and lower segment housings 15 and 16 (see FIG. 2) rows of flat or hole nozzles 17 that are supplied with air as shown for example in FIG. 3 by blowers 18. FIG. 2 further shows wholly schematically at 19 that air is vented from the turntable 7. The double-headed arrow 20 shown in FIG. 2 indicates how at least the upper segment housing 15 with its cooler 17 or 17a, 17c is raisable and lowerable at least in the loading zone so that this double-length segment housing can when the press is operating be lifted into an out-of-the-way position for loading.

The cooling system shown in FIG. 3 has coolers 17a, 17b, and 17c provided above, below, and next to the cooling zones 14a to 14f for the extruded profiles 4. The extruded profiles 4, 4a, and 4b can thus be cooled on all sides by the uniformly spaced flat or hole nozzles of the coolers 17a, 17b, and 17c.

In the embodiment of FIG. 2 there is an alternative structure which combines with a turntable 7 a straight-line roller conveyor 21 when the extruder 1 (see FIG. 1) is used to make unillustrated straight profiles. In this case the turntable 7 is not rotated; instead it is positioned such that the roller conveyor 21 can be moved in tangentially from an out-of the way position toward the turntable 7 such that in this embodiment the spokes 11 fit between adjacent rollers.

Here also the extruded uncooled profiles move past flat or hole-type nozzles 117 underneath the roller conveyor 21 as well as under nozzles 117a provided overhead in hoods 22 and nozzles 117b provided to the side. In this manner an extruder 1 can be used not only to make curved extruded profiles, but also can make straight profiles and in both cases can cool them intensively with a zoned and controlled cooling.

1. An apparatus for extruding curved profiles, the extruded profiles being formed in a die held in a frame of an extruder and then being curved or bent by the application of an external force, and then cut downstream into lengths that are conveyed away for cooling,
characterized in that
a turntable (7) is provided at a press outlet (I) to receive the curved extruded profiles.

2. The apparatus according to claim 1,
characterized in that
above and/or below the turntable (7) there are coolers (17a, 17b; 15, 16; 17).

3. The apparatus according to claim 2,
characterized by
coolers (17c) provided to the side of the curved extruded profiles (4; 4a, 4b).

4. The apparatus according to claim 2,
characterized in that
the coolers (17a, 17b, 17c; 15, 16; 17) are grouped in zones.

5. The apparatus according to claim 2,
characterized in that
the coolers (17a, 17b, 17c; 17) are mounted in segment-like housings (15 and 16).

6. The apparatus according to claim 3,
characterized in that
the coolers (15a, 17c; 15, 17) can be raised and lowered.

7. The apparatus according to claim 1,
characterized in that
the turntable (7) is provided with spoke-like arms (11).

8. The apparatus according to claim 1,
characterized in that
the turntable (7) has at least one loading station and one unloading station.

9. The apparatus according to claim 1,
characterized by
a combined loading and unloading station (11).

10. The apparatus according to claim 1,
characterized by
air-exhaust conduits (19) provided on the turntable (7).

11. The apparatus according to claim 1,
characterized in that
the turntable (7) is combined with a straight roller conveyor (21).

12. The apparatus according to claim 11,
characterized in that
the straight roller conveyor (21) is provided with coolers (117; 22; 117a, 117b).
